(19) United States
(12) Patent Application Publication
(10) Pub. No.: US 2013/0156431 A1
(43) Pub. Date: Jun. 20, 2013

(54) SYSTEM AND METHOD FOR MULTIPLE SUB-OCTAVE BAND TRANSMISSIONS

(71) Applicants: Chen-Kuo Sun, Escondido, CA (US); Peter H. Wolff, Apollo Beach, FL (US)

(72) Inventors: Chen-Kuo Sun, Escondido, CA (US); Peter H. Wolff, Apollo Beach, FL (US)

(21) Appl. No.: 13/765,585

(22) Filed: Feb. 12, 2013

Related U.S. Application Data
(63) Continuation-in-part of application No. 12/980,008, filed on Dec. 28, 2010.

(51) Int. Cl. H04B 10/2507

(52) U.S. Cl. CPC H04B 10/2507
USPC 398/58

(57) ABSTRACT

A system and method for enabling multiple sub-octave band transmissions with reduced second order distortions is provided. For this method, first and second sub-octave bands are established. The second sub-octave band is spaced from the first sub-octave band by a non-transmission band. Digital signals are modulated onto RF carrier frequencies in the first and second band to produce first band RF signals and second band RF signals. The first and second band signals are converted into one or more light beams and transmitted over a fiber optic cable. After transmission, an optical receiver reconverts the light beam into an RF signal. Second order distortions outside a selected sub-octave band can be filtered from RF signal and a tuner used to tune in a selected carrier frequency. A receive modem can then be used to demodulate the tuned carrier frequency for receipt of its respective digital signal.

This application is a continuation-in-part application of U.S. patent Ser. No. 12/980,008, filed Dec. 28, 2010 to inventor Chen-Kuo Sun, (attorney docket number 11576.2) the entire contents of which are hereby incorporated by reference herein.

### FIELD OF THE INVENTION

The present invention pertains generally to systems and methods that enable transmissions of data over optical fibers. More particularly, the present invention pertains to systems and methods for transmitting digital signals over fiber optic networks with subsequent sub-octave filtering to remove second order distortions from the signals. The present invention is particularly, but not exclusively, useful as a system and method for using a Passive Optical Network (PON) to transmit digital signals with subsequent sub-octave filtering.

### BACKGROUND OF THE INVENTION

A Passive Optical Network (PON) is essentially an optical network that uses a single fiber optic cable for the transmission of signals from one point (e.g. a service provider) to a plurality of different points (e.g. customer premises). Most likely, the signals to be transmitted will be digital signals. Therefore, in addition to the fiber optic cable, the PON will necessarily include a component (i.e. modem) at the transmit end of the fiber optic cable that modulates digital signals onto a radio frequency (RF) carrier wave. The resulting RF signal is then converted into an optical signal for transmission over the fiber optic cable. At the receive end of the fiber optic cable, the process is reversed. Specifically, a component (modem) reconverts the optical signal to an RF signal, and then demodulates the RF signal for subsequent use.

An important aspect of a PON is that it can take advantage of the well known transmission of optical signals by Wavelength-Division Multiplexing (WDM). This essentially allows the PON to use one wavelength (λ₁) for downstream traffic on the fiber optic cable, while simultaneously using another wavelength (λ₂) for upstream traffic. Further, it is possible to have two or more upstream traffic wavelengths (e.g. λ₁ and λ₃), and two or more downstream traffic wavelengths (e.g. λ₂ and λ₄). This WDM capability, coupled with the point-to-multipoint characteristics of the PON, gives it a distinct advantage over other types of network architectures. Specifically, a PON configuration will reduce the amount of fiber optic cable that is required vis-à-vis a point to point architecture. A potential downside, however, is that fiber optic cables are known to introduce distortions into an optical signal that diminish its clarity.

Of all the distortions that may be introduced into an optical signal as it transits through a fiber optic cable, the most predominant distortion is the second order distortion. These second order distortions, however, are relatively easily identified. For example, consider an optical signal carrying RF frequencies fₐ and f_{b}. It can happen that the fiber optic cable will induce two RF distortion signals at frequencies fₐ+f_{b} and fₐ−f_{b} into the optical signal as it transits through the fiber optic cable. In the case where fₐ≅f_{b}, the second order distortions are fₐ+f_{b}≅2fₐ and fₐ−f_{b}≅0. In this case, fₐ−f_{b}≅0 is trivial and 2fₐ defines the octave for fₐ.

In light of the above, an object of the present invention is to provide a passive optical network with a sub-octave filter that will transmit clear signals over the PON with minimal, if any, distortions at the receive end of the transmission. Another object of the present invention is to provide a passive optical network that effectively removes distortions from a transmitted signal that are induced into the signal by the fiber optic cable of the PON. Yet another object of the present invention is to provide systems and methods for transmitting digital signals on RF carrier frequencies within multiple sub- octave frequency bands with reduced second order distortions. Another object of the present invention is to use RF carrier frequencies within multiple sub-octave frequency bands to increase transmission bandwidth with reduced second order distortions. Still another object of the present invention is to provide a system and method for multiple sub-octave band transmissions that are easy to use, simple to employ and comparatively cost effective.

### SUMMARY OF THE INVENTION

In accordance with the present invention, a Passive Optical Network (PON) incorporates a band pass filter for removing second order distortions from an optical signal that are induced when a light beam is transmitted through a fiber optic cable in the PON. In accordance with the present invention, the optical signal from the fiber optic cable is converted to an RF signal, and the RF signal is filtered in the sub-octave bandwidth that includes the RF carrier frequency of the digital signal. The RF signal can then be demodulated for subsequent reception of the digital signal.

Structurally, the Passive Optical Network (PON) of the present invention includes a transmit modem for modulating a plurality of digital signals onto respective RF carrier frequencies (f). This can be done by either amplitude modulation, frequency modulation, or phase modulation. An optical transmitter with the modem is also used to convert each of these modulated carrier frequencies into an optical signal. A Wavelength-Division Multiplexer (WDM) is then used to combine the optical signal with other, similarly formed optical signals to create a light beam. Importantly, in the light beam each optical signal will have its own separate wavelength (λ).

For the present invention, an optical fiber cable is provided for transmitting the light beam over the PON between an Optical Line Terminal (OLT) [e.g. a service provider] and a plurality of Optical Network Units (ONU) [e.g. customers]. In detail, the optical fiber will have a first end that is connected to the OLT for receiving the light beam from the transmitter and the WDM. The light beam is then transferred through the optical fiber to its second end. A splitter, which is connected to the second end of the optical fiber, is used for splitting the light beam into subsets. As envisioned for the present invention, each subset will be sent to a respective ONU, and it will include all of the optical signals in the transmitted light beam, albeit at reduced power.

A plurality of optical receivers is positioned at respective customers (i.e. ONUs) in the network to receive a subset from the light beam. Each optical receiver then functions with a modem to reconvert optical signals in the subset back to their respective modulated carrier frequencies. A sub-octave band pass filter then filters out the second order distortions that are outside the sub-octave of the modulated carrier frequency. Thus, second order distortions are removed from the received signals.

Once the received signals have been reconverted and filtered, a tuner is used to tune in a selected carrier frequency and to direct the selected carrier frequency to an addressed premise in the ONU. The receive modem then demodulates the tuned carrier frequency to reconstruct its respective digital signal. The digital signal can then be used for its intended purpose.

Operationally, a method of the present invention for enabling a sub-octave transmission of a digital signal over a passive optical network (PON) relies on establishing a sub-octave bandwidth for each of a plurality of discrete carrier frequencies (f). Initially, the method envisions modulating a digital signal onto a selected carrier frequency (f) and then converting the modulated carrier frequency into an optical signal. With this conversion, the optical signal and the digital signal will both have a same wavelength (λ). Several such optical signals can be correspondingly formed and combined together into the light beam. In the event, the light beam is introduced into the first end of a fiber optic cable and is transmitted through the fiber optic cable from the first end to a second end.

At the second end of the fiber optic cable, the light beam is split into subsets, wherein each subset includes all of the optical signals of the originally transmitted beam. Each subset of the light beam is then directed to a designated optical receiver at a respective ONU where it is reconverted to the modulated carrier frequency. At this point, the second order distortions that are outside the established sub-octave are filtered from the modulated carrier frequency. A tuner can then be used to tune in a selected modulated carrier frequency, and a receive modem can be used to demodulate the tuned carrier frequency for receipt of its respective digital signal.

As envisioned for the present invention, establishing the sub-octave involves identifying a first octave bounded by a low carrier frequency (f_{L1}) and a high carrier frequency (f_{H1}). This first octave will be used by a forward (downstream) transmit light beam. Importantly, 2f_{L1}≧f_{H1}>f_{L1}. Also, a second octave is identified which is bounded by a low carrier frequency (f_{L2}) and a high carrier frequency (f_{H2}). This second octave will be used by a return (upstream) receive light beam, wherein 2f_{L2}≧f_{H2}>f_{L2}. For the present invention, the forward (downstream) transmit light beam and the return (upstream) receive light beam will include carrier frequencies in a range between 750 MHz and 40 GHz. Further, it is contemplated that embodiments of the present invention may employ two PONs on the same optical fiber cable. For these embodiments, the present invention envisions adding bandwidth below f_{L1} for use by a forward (downstream) transmit light beam (e.g. λ₃) in the second PON, and bandwidth below f_{L2} for use by a return (upstream) receive light beam (e.g. λ₄) in the second PON.

In another aspect of the present invention, a system and method for enabling multiple sub-octave band transmissions with reduced second order distortions is provided. For this aspect of the invention, a first sub-octave band having a plurality of discrete carrier frequencies, extending from F₁ to F₂, with F₂<2F₁ is established. With the first sub-octave band established, digital signals are modulated onto RF carrier frequencies in the first band to produce first band RF signals. In addition, for this aspect, a second sub-octave band is established having a plurality of discrete carrier frequencies, extending from F₃ to F₄, with F₄<F₁+F₃. With the second sub-octave band established, digital signals are modulated onto RF carrier frequencies in the second band to produce second band RF signals.

For this aspect of the present invention, the second sub-octave band is spaced from the first sub-octave band by a non-transmission band (i.e. a non-transmission band between F₂ and F₃). Moreover, to reduce second order distortions, the non-transmission band is established with F₃>2F₂. Additional bands can be employed above the second band or below the first band. The bandwidth of the additional bands and non-transmission bands between bands can be calculated using the techniques provided herein to reduce or eliminate the effects of second order distortions. Typically, frequencies in the bands described above are in a range of frequencies between 750 MHz and 40 GHz.

Typically, to modulate the digital signals into the sub-octave bands, a frequency upconverter is used. For example, digital signal may first be modulated onto an initial RF carrier frequency, F₀, using a modem to produce an initial modulated RF signal. Then, the initial modulated RF signal is up-converted from the carrier frequency, F₀, to a carrier frequency within the first band (i.e. to a frequency between F₁ and F₂). It is to be appreciated that up-conversion can be used to modulate digital signals into the other sub-octave bands (i.e. the second and third bands described above).

With the digital signals modulated on carrier frequencies within the first and second bands (or third band, if applicable), the first and second band signals are converted into one or more light beams. For example, one or more transmitters may be employed to convert the first and second band signals are converted into one or more light beams. In one implementation, the first and second band RF signals are first combined into a combined RF signal and the combined RF signal is converted into a light beam by a transmitter. In some cases, the first and second band signals are converted into a light beam having wavelength (λ₁) and this light beam having wavelength (λ₁) is multiplexed with another light beam having wavelength (λ₂) using wavelength division multiplexing prior to transmission. For example, the light beam having wavelength (λ₂) may be generated by another, similarly configured system.

Next, the light beam(s) are introduced into a fiber optic cable for transmission through the fiber optic cable. For example, the light beam(s) having the first and second band signals may be introduced into a same end (i.e. first end) of the fiber optic cable for transmission to a second cable end. In some cases, the first and second band signals are converted into a light beam having wavelength (λ₁), and the light beam having wavelength (λ₁) is multiplexed with another light beam having wave length (λ₂) using wavelength division multiplexing prior to introducing the light beam into the fiber optic cable. At the second end of the fiber optic cable, the digital signals can be recovered from the light beam(s). For example, a first band signal can be retrieved from a light beam at the second end of the fiber optic cable by first splitting the light beam received at the second end into subsets that each include all of the signals of the originally transmitted beam(s). Each subset of the light beam is then directed to a designated optical receiver where it is reconverted into an RF signal. At this point, the second order distortions that are outside the first sub-octave band are filtered from the RF signal, for example using a band pass filter. A tuner can be used to tune in a selected modulated carrier frequency in the first band. From the tuner, a receive modem can be used to demodulate the tuned carrier frequency for receipt of its respective digital signal. A similar process can be used to recover digital signals in the other sub-octave bands such as the second sub-octave band.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic layout of the component elements of a Passive Optical Network (PON) in accordance with the present invention;

FIG. 2 is an operational flow chart of the methodology of the present invention; and

FIG. 3 is a frequency diagram showing sub-octave carrier frequency bands separated by non-transmission bands.

### DESCRIPTION OF THE PREFERRED EMBODIMENTS

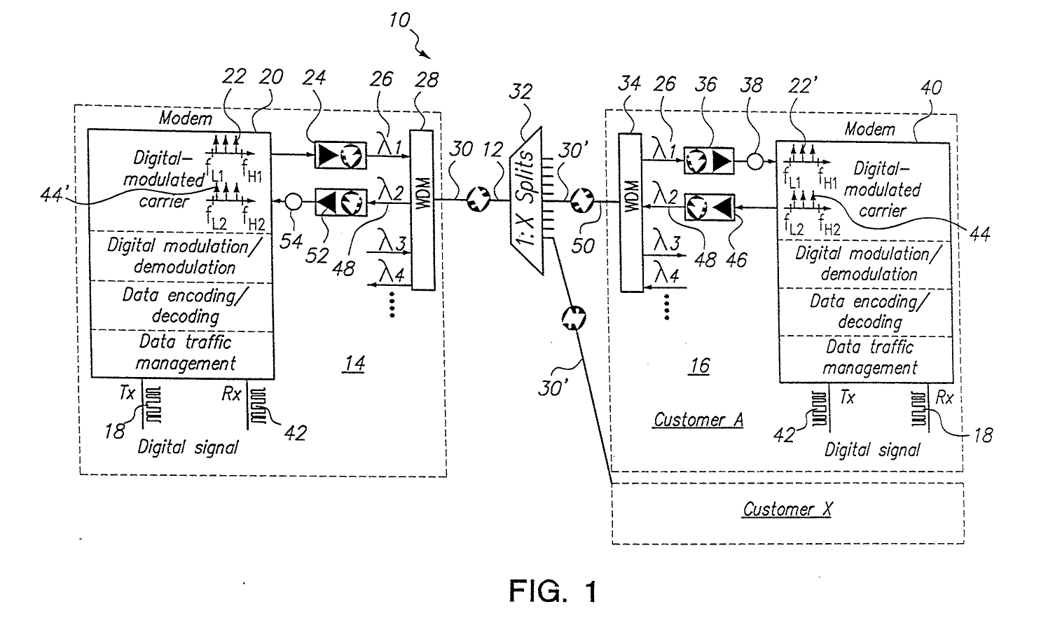

Referring initially to FIG. 1, component elements of a Passive Optical Network (PON) in accordance with the present invention are shown collectively and generally designated 10. As shown, the PON 10 includes a fiber optic cable (optical fiber) 12 that interconnects an Optical Line Terminal (OLT) 14 (e.g. a service provider) with a plurality of Optical Network Units (ONU) 16 (e.g. customers). In FIG. 1, the ONU 16 is only exemplary, and is shown to be servicing Customer A.

As indicated in FIG. 1, a digital signal 18 that is to be transmitted over the PON 10 is modulated by the modem 20. For purposes of the PON 10, this modulation may be either an amplitude modulation, a frequency modulation, phase modulation, or any combination of the three. In any event, the digital signal 18 is modulated onto an RF carrier frequency (f₁) in a manner well known in the pertinent art. In FIG. 1, it is shown that the modulated carrier frequency 22 (i.e. f₁) is established in a sub-octave that is bounded by a low carrier frequency f_{L1} and a high carrier frequency f_{H1}. Once the sub-octave is established, the now-modulated carrier frequency 22 is passed to a transmitter 24 where it is converted into an optical signal 26 (i.e. an optical signal with wavelength λ₁). In turn, the optical signal 26 (λ₁) is sent to a Wavelength-Division Multiplexer 28 (WDM) where it is combined with other optical signals (e.g. λ₃) into a light beam 30 for downstream transmission over the fiber optic cable 12. As shown in FIG. 1, the fiber optic cable 12 is connected between the WDM 28 and a splitter 32.

After the optical signal 26 on light beam 30 has been transmitted over the fiber optic cable 12, the light beam 30 is split at the splitter 32 into a plurality of subset light beams 30′. Importantly, each subset light beam 30′ includes all of the optical signals (e.g. λ₁ and λ₂) that were combined together at the WDM 28. Further each subset light beam 30′ is then sent to a respective ONU 16. Operationally, the WDM 34 at ONU 16 (i.e. Customer A) receives the same subset light beam 30′ as does every other ONU 16 in the PON 10 (e.g. Customer X). For the specific example of customer A, the optical signal (λ₁) 26 that is in the subset light beam 30′ received by ONU 16, is sent to a receiver 36 where it is reconverted into its modulated carrier frequency 22′ (i.e. f₁). This modulated carrier frequency 22′ (f₁) is then filtered by a band pass filter 38 and is demodulated by the modem 40. The consequence of this is that the digital signal 18 that is being carried by a filtered carrier frequency 22′ is received at the ONU 16 with all impairments caused by second order distortions effectively removed from the digital signal 18.

Although the above disclosure has focused on a downstream transmission from OLT 14 to ONU 16, an upstream transmission from ONU 16 to the OLT 14 is similar and essentially operates in reverse. Specifically, for an upstream transmission, a digital signal 42 is modulated at the modem 40 onto an RF carrier frequency (f₂) in a manner as similarly disclosed above for f₁. In this instance, a modulated carrier frequency 44 (i.e. f₂) is established in a sub-octave that is bounded by a low carrier frequency f_{L2} and a high carrier frequency f_{H2}. The modulated carrier frequency 44 is then passed to a transmitter 46 where it is converted into an optical signal 48 (i.e. an optical signal with wavelength λ₂). In turn, the optical signal 48 (λ₂) is sent to the Wavelength-Division Multiplexer 34 (WDM) where it can be combined with other optical signals (e.g. λ₄) into a light beam 50 for an upstream transmission over the fiber optic cable 12. The light beam 50 is then received by OLT 14, processed through the Wavelength-Division Multiplexer 28 and sent to a receiver 52 where the optical signal 48 in the light beam 50 is reconverted into its modulated carrier frequency 44′ (i.e. f₂). This modulated carrier frequency 44 (f₂) is then filtered by a band pass filter 54, and it is subsequently demodulated by the modem 20. The consequence of this is that the digital signal 42 is received at the OLT 14 with all impairments caused by second order distortions being effectively removed from the digital signal 42.

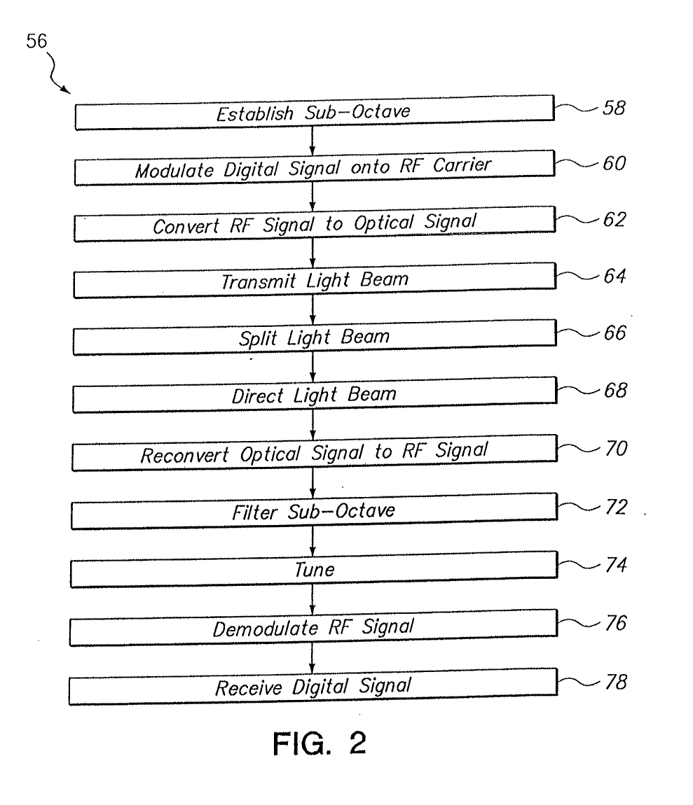

FIG. 2 presents a step-by-step methodology, generally designated 56, which indicates that an initial consideration for an operation of the PON 10 is the establishment of a sub-octave (see block 58). Specifically, a sub-octave is established for each transmission (downstream/upstream). To transmit a digital signal 18/42 over the PON 10, block 60 indicates that the digital signal 18/42 is modulated onto a carrier frequency 22 (f₁)/44 (f₂). Block 62 then indicates that the modulated carrier frequency 22 (f₁)/44 (f₂) is converted to an optical signal 26 (λ₁)/48 (λ₂). The optical signal 26 (λ₁) /48 (λ₂) can then be combined with other such signals at a WDM 28/34 and transmitted (downstream/upstream), as a light beam 30/50 over the fiber optic cable 12 (see block 64).

Insofar as the light beam 30 is specifically concerned, block 66 indicates that the light beam 30 is split into subset light beams 30′. Each subset light beam 30′ is then directed to a particular ONU 16 (see block 68) where it is converted back (see block 70) from an optical signal 26 (λ₁)/48 (λ₂) to an RF modulated carrier frequency 22 (f₁)/44 (f₂). The RF modulated carrier frequency 22 (f₁)/44 (f₂) is then filtered (see block 72). More specifically, as indicated above, a unique sub-octave is established for use by each of the band pass filters 38 and 54 to respectively remove second order distortions from the downstream light beam 30 and from the upstream light beam 50, after the light beams 30/50 have been transmitted through the fiber optic cable 12. After the optical signals 26 (λ₁)/48 (λ₂) have been reconverted to respective RF modulated carrier frequencies 22′ (f₁)/44′ (f₂), and the second order distortions have been removed from the RF modulated carrier frequencies 22′ (f₁)/44′ (f₂), block 74 indicates a user can tune for a carrier frequency of interest (e.g. modulated carrier frequency 22 (f₁)). The modulated carrier frequency 22 (f₁) is then demodulated by a modem 20/40 (see block 76) and the digital signal 18/42 is received for use without any appreciable impairments caused by second order distortions in the transmission process (see block 78).

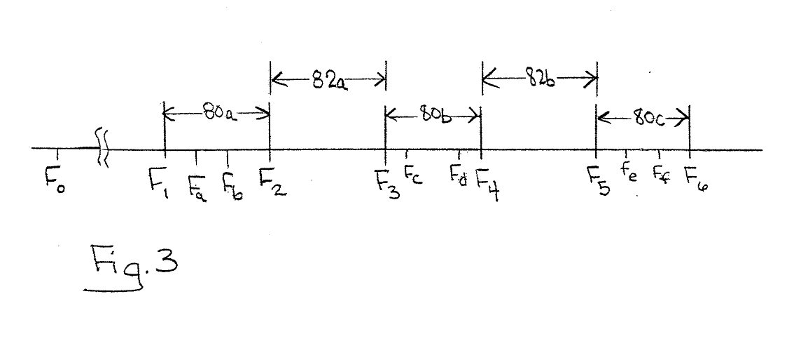

FIG. 3 is a frequency diagram showing sub-octave carrier frequency bands 80a-c that can be used to transmit signals over a common optical transmission path with reduced second order distortions. As shown, first band 80a is established that extends from F₁ to F₂ and has a sub-octave frequency bandwidth such that F₂<2F₁. For the first band 80a, a plurality of discrete RF carrier frequencies, such a Fₐ and F_{b} can be modulated with respective digital signals to produce respective first band RF signals, for example using modem 20 shown in FIG. 1. Also shown, second band 80b is established that extends from F₃ to F₄ and has a sub-octave frequency bandwidth such that F₄<F₁+F₃. For the second sub-octave carrier frequency band 80b, a plurality of discrete RF carrier frequencies, such as F_{c} and F_{d} can be modulated with respective digital signals to produce respective second band RF signals, for example using modem 20 shown in FIG. 1. FIG. 3 further shows that a third sub-octave carrier frequency band 80c can be is established that extends from F₅ to F₆, with F₆>F₅>F₄. For the third band 80c, a plurality of discrete RF carrier frequencies, such as Fₑ and F_{f} can be modulated with respective digital signals to produce respective third band RF signals, for example using modem 20 shown in FIG. 1. Although three sub-octave carrier frequency bands 80a-c are shown in FIG. 3 and described herein, it is to be appreciated that more than three and as few as two sub-octave carrier frequency bands 80a-c may be used as part of a multiple, sub-octave band transmission system.

FIG. 3 further shows that the sub-octave carrier frequency bands 80a-c are separated by non-transmission bands 82a,b. Specifically, as shown, sub-octave carrier frequency band 80a is separated from sub-octave carrier frequency band 80b by non-transmission band 82a and sub-octave carrier frequency band 80b is separated from sub-octave carrier frequency band 80c by non-transmission band 82b.

The non-transmission bands 82a,b are sized having sufficient bandwidth to reduce second order distortions. For example, the non-transmission band 82a is established with a bandwidth such that F₃>2F₂ (i.e. the non-transmission band 82a has a bandwidth greater than an octave). With this arrangement, second order distortions from the sub-octave carrier frequency band 80a, which include 2F₁, 2F₂, F₁+F₂ and F₂−F₁, will not interfere with sub-octave carrier frequency band 80b and second order distortions from the sub-octave carrier frequency band 80b, which include 2F₃, 2F₄, F₃+F₄ and F₄-F₃, will not interfere with sub-octave carrier frequency band 80a.

With the actual frequencies F₁, F₂, F₃ and F₄ determined, the bandwidth of the third band (i.e. sub-octave carrier frequency band 80c) and non-transmission band 82b can be determined. Specifically, a non-transmission band between 2F₃ and 2F₄ will ensure that reduce or eliminate second order distortions between the sub-octave carrier frequency band 80b and sub-octave carrier frequency band 80c. Specifically, with this arrangement, second order distortions from the sub-octave carrier frequency band 80b, which include 2F₃, 2F₄, F₃+F₄ and F₄−F₃, will not interfere with sub-octave carrier frequency band 80c and second order distortions from the sub-octave carrier frequency band 80c, which include 2F₅, 2F₆, F₅+F₆ and F₆−F₅, will not interfere with sub-octave carrier frequency band 80b.

The third band (i.e. sub-octave carrier frequency band 80c) can be established with F₅>2F₄ and F₆<F₅+F₁. In some cases, depending on the sizes of the sub-octave carrier frequency bands 80a and 80b and non-transmission band 82a, the third band (i.e. sub-octave carrier frequency band 80c) can include carrier frequencies below 2F₃. For this case, sub-octave carrier frequency band 80c can be established with F₅>F₂+F₄ and F₆ being less than the smaller of 2F₃ or F₁+F₆. Typically, frequencies in the sub-octave carrier frequency bands 80a-c are in a range of frequencies between about 750 MHz and about 40 GHz.

Continuing with FIG. 3, a frequency upconverter (not shown) can be used as part of modem 20 (shown in FIG. 1) to modulate the digital signals into the sub-octave carrier frequency bands 80a-c. For example, a digital signal may first be modulated onto an initial RF carrier frequency, F₀, (see FIG. 3) using modem 20 to produce an initial modulated RF signal. Then, the initial modulated RF signal is up-converted from the carrier frequency, F₀, to a carrier frequency within one of the sub-octave carrier frequency bands 80a-c.

With digital signals modulated on carrier frequencies within the sub-octave carrier frequency bands 80a-c, the signals can be converted into a light beam having wavelength (λ₁) using a transmitter 24 as shown in FIG. 1. Also shown in FIG. 1, the light beam having wavelength (λ₁) can be multiplexed with other light beams such as a light beam having wavelength (λ₂) using wavelength division multiplexing 28.

Continuing with FIG. 1, the light beam(s) can then be introduced into a fiber optic cable 12 for transmission. At the second end of the fiber optic cable 12, the digital signals can be recovered from the light beam(s). For example, a signal from sub-octave carrier frequency band 80a can be retrieved from a light beam at the second end of the fiber optic cable 12 by first splitting the light beam received at the second end at a splitter 32 into subsets that each include all of the signals of the originally transmitted beam(s). Each subset of the light beam is then directed to a designated optical receiver 36 where it is reconverted into an RF signal. At this point, the second order distortions that are outside the sub-octave carrier frequency band 80a are filtered from the RF signal, for example using a band pass filter 38. A tuner can be used to tune in a selected modulated carrier frequency in the sub-octave carrier frequency band 80a. A receive modem 40 can be used to demodulate the tuned carrier frequency for receipt of its respective digital signal. A similar process can be used to recover digital signals in the other sub-octave carrier frequency bands 80a-c such as the sub-octave carrier frequency band 80b and sub-octave carrier frequency band 80c.

While the particular Passive Optical Network with Sub-Octave Transmission as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for enabling multiple sub-octave band transmissions with reduced second order distortions, the method comprising the steps of:
establishing a first sub-octave band having a plurality of discrete carrier frequencies, including F₁ and F₂, with F₂>F₁;
modulating digital signals onto Radio Frequency (RF) carrier frequencies in the first band to produce first band RF signals;
establishing a second sub-octave band having a plurality of discrete carrier frequencies, including F₃ and F₄, with F₄>F₃ and wherein the second band is spaced from the first band by a non-transmission band between F₂ and F₃, with F₃>2F₂;
modulating digital signals onto RF carrier frequencies in the second band to produce second band RF signals;
converting the first and second band signals into one or more light beams; and
introducing said one or more light beams into a fiber optic cable for transmission through the fiber optic cable.

2. A method as recited in claim 1 wherein the first band extends from F₁ to F₂ and the second band extends from F₃ to F₄.

3. A method as recited in claim 1 wherein F₂<2F₁.

4. A method as recited in claim 1 wherein F₄<F₁+F₃.

5. A method as recited in claim 1 wherein the first and second band signals are introduced into a same end of the fiber optic cable in the introducing step.

6. A method as recited in claim 1 wherein the step of modulating digital signals onto Radio Frequency (RF) carrier frequencies in the first band to produce first band RF signals comprises the sub-steps of:
modulating a digital signal onto an initial RF carrier frequency, F₀, to produce an initial modulated RF signal; and
up-converting the initial modulated RF signal to up-convert the carrier frequency, F₀, to a carrier frequency within the first band.

7. A method as recited in claim 1 wherein said converting step converts the first and second band signals into a light beam having wavelength (λ₁).

8. A method as recited in claim 7 further comprising the step of multiplexing the light beam having wavelength (λ₁) with another light beam having wavelength (λ₂) using wavelength division multiplexing prior to said introducing step.

9. A method as recited in claim 1 further comprising the step of combining the first and second band signals into a combined RF signal prior to said converting step.

10. A method as recited in claim 1 further comprising the steps of:
establishing a third sub-octave band having a plurality of discrete carrier frequencies, including F₅ and F₆, with F₆>F₅ and wherein the third band is spaced from the second band by a non-transmission band between F₄ and F₅, with F₅>2F₄;
modulating digital signals onto RF carrier frequencies in the third band to produce third band RF signals; and
wherein the converting step converts the first, second and third band signals into one or more light beams; and
wherein the introducing step introduces the one or more light beams with the first, second and third band signals into a fiber optic cable for transmission through the fiber optic cable.

11. A method as recited in claim 1 further comprising the steps of:
recovering a first band signal from a light beam retrieved from the fiber optic cable;
filtering second order distortions outside the first sub-octave band from the recovered first band signal; and
demodulating a digital signal from the filtered, first band signal.

12. A method as recited in claim 11 wherein the filtering step is accomplished using a band pass filter.

13. A method as recited in claim 1 wherein the frequency, F₁, is in a range of frequencies between 750 MHz and 40 GHz.

14. A method for multiple sub-octave band transmission of signals, the method comprising the steps of:
modulating digital signals onto RF carrier frequencies in discrete first and second sub-octave bands to produce respective first band signals and second band signals wherein the first band is separated from the second band by more than one octave;
converting the first and second band signals into one or more light beams for transmission through a fiber optic cable;
recovering a first band signal from a light beam retrieved from the fiber optic cable;
filtering second order distortions outside the first sub-octave band from the recovered first band signal; and
demodulating a digital signal from the filtered, first band signal.

15. A method as recited in claim 14 wherein the first band extends from F₁ to F₂, the second band extends from F₃ to F₄ and the second band is spaced from the first band by a non-transmission band between F₂ and F₃, with F₃>2F₂.

16. A method as recited in claim 15 wherein F₂<2F₁ and F₄<F₁+F₃.

17. A system for multiple sub-octave band transmission of signals comprising:
at least one modem modulating digital signals onto RF carrier frequencies in first and second sub-octave bands to produce first band signals and second band signals;
at least one transmitter converting the first and second band signals into one or more light beams for transmission through a fiber optic cable;
a receiver recovering a first band signal from a light beam retrieved from the fiber optic cable;
a band pass filter filtering second order distortions outside the first sub-octave band from the recovered first band signal; and
a modem demodulating a digital signal from the filtered, first band signal.

18. A system as recited in claim 17 wherein the first band extends from F₁ to F₂, the second band extends from F₃ to F₄ and the second band is spaced from the first band by a non-transmission band between F₂ and F₃, with F₃>2F₂.

19. A system as recited in claim 17 wherein the first band extends from F₁ to F₂, the second band extends from F₃ to F₄, F₂<2F₁.

20. A method as recited in claim 19 wherein F₄<F₁+F₃.
